(19) United States
(12) Patent Application Publication
(10) Pub. No.: US 2018/0114134 A1
(43) Pub. Date: Apr. 26, 2018

(54) IDENTIFYING OWNERS OF FOUND ITEMS

(71) Applicant: International Business Machines Corporation, Armonk, NY (US)

(72) Inventors: Jesus G. Alva, Cedar Park, TX (US); Ketaki Borkar, Campbell, CA (US); Ricardo N. Olivieri, Austin, TX (US); Leigh A. Williamson, Austin, TX (US)

(21) Appl. No.: 15/333,239

(22) Filed: Oct. 25, 2016

(51) Int. Cl. G06N 7/00; G06N 99/00

(52) U.S. Cl. CPC G06N 7/005; G06N 99/005

(57) ABSTRACT

Approaches presented herein enable identification of an owner of a misplaced item. More specifically, an owner identification system receives information about an item from a finder of the item and generates, based on the information, a found item profile including characteristics historically associated with typical owners of such an item. The system generates a set of profiles of user preferences based on social media activity of the users and determines, based on a comparison of the found item profile with the user preferences profile, a likelihood that the user is the owner of the item. Based on this determination, the finder of the item can be notified of an identification of a potential owner. Successful matches between found items and their owners can be entered into a cognitive learning system to improve future outcomes.

### TECHNICAL FIELD

This invention relates generally to identifying an owner of a misplaced item and, more specifically, to building profiles of a set of possible owners to match the misplaced item to an owner.

### BACKGROUND

In today's fast-paced, well-traveled world, it is not unusual to occasionally lose, misplace, or mislay an item of personal property. Furthermore, the wide variety of locations a person may go to, such as eating establishments, stores, parks, public transportation, and vacation locations, present a number of opportunities to misplace an item of personal property. Although some finders of lost items may wish to keep the item for themselves, most people are inclined to try to return a lost item to its owner. Unfortunately, in many cases, the lost item is never recovered because the finder has no way to contact the owner. Existing attempts to locate an owner, such as a lost and found at the location the item was found (e.g., a customer service desk), a government building (e.g., a police station), or an online forum (e.g., a classifieds website), often fail because they require the owner of the item to retrace his/her steps and/or to correctly guess which third-party lost and found a finder took the item to or left a posting about the item on. Furthermore, if an item goes unclaimed after a certain period has passed, most third-party lost and founds must either sell, give, or throw away the item to clear their storage.

### SUMMARY

In general, embodiments described herein provide for identification of an owner of a misplaced item. More specifically, an owner identification system receives information about an item from a finder of the item and generates, based on the information, a found item profile including characteristics historically associated with typical owners of such an item. The system generates a set of profiles of user preferences based on social media activity of the users and determines, based on a comparison of the found item profile with the user preferences profile, a likelihood that the user is the owner of the item. Based on this determination, the finder of the item can be notified of an identification of a potential owner. Successful matches between found items and their owners can be entered into a cognitive learning system to improve future outcomes.

One aspect of the present invention includes a computer-implemented method for identifying an owner of a misplaced item, the computer-implemented method comprising: receiving information about a found item from a finder of the found item; generating, based on the received information, a found item profile comprising a set of characteristics historically associated with owners of the found item; generating a user preferences profile comprising a set of preferences of a user; determining, based on a comparison of the found item profile with the user preferences profile, a likelihood that the user is the owner of the found item; and notifying, in response to the likelihood being above a predetermined threshold, the finder of an identification of a potential owner based on the determination.

Another aspect of the present invention includes a computer system for identifying an owner of a misplaced item, the computer system comprising: a memory medium comprising program instructions; a bus coupled to the memory medium; and a processor, for executing the program instructions, coupled to a found item owner identifier via the bus that when executing the program instructions causes the system to: receive information about a found item from a finder of the found item; generate, based on the received information, a found item profile comprising a set of characteristics historically associated with owners of the found item; generate a user preferences profile comprising a set of preferences of a user; determine, based on a comparison of the found item profile with the user preferences profile, a likelihood that the user is the owner of the found item; and notify, in response to the likelihood being above a predetermined threshold, the finder of an identification of a potential owner based on the determination.

Yet another aspect of the present invention includes a computer program product for identifying an owner of a misplaced item, the computer program product comprising a computer readable storage device, and program instructions stored on the computer readable storage device, to: receive information about a found item from a finder of the found item; generate, based on the received information, a found item profile comprising a set of characteristics historically associated with owners of the found item; generate a user preferences profile comprising a set of preferences of a user; determine, based on a comparison of the found item profile with the user preferences profile, a likelihood that the user is the owner of the found item; and notify, in response to the likelihood being above a predetermined threshold, the finder of an identification of a potential owner based on the determination.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments;

FIG. 2 depicts a cloud computing environment according to illustrative embodiments of the present invention;

FIG. 3 depicts abstraction model layers according to illustrative embodiments of the present invention;

FIG. 4 shows a more detailed system architecture for implementing identification of an owner of a found item based on a preferences profile of the owner according to illustrative embodiments;

FIG. 5 shows an illustrative embodiment of identifying an owner of a found item based on a preferences profile of the owner according to illustrative embodiments; and

FIG. 6 shows a process flowchart for identifying an owner of a misplaced item according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for identification of an owner of a misplaced item. More specifically, an owner identification system receives information about an item from a finder of the item and generates, based on the information, a found item profile including characteristics historically associated with typical owners of such an item. The system generates a set of profiles of user preferences based on social media activity of the users and determines, based on a comparison of the found item profile with the user preferences profile, a likelihood that the user is the owner of the item. Based on this determination, the finder of the item can be notified of an identification of a potential owner. Successful matches between found items and their owners can be entered into a cognitive learning system to improve future outcomes.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

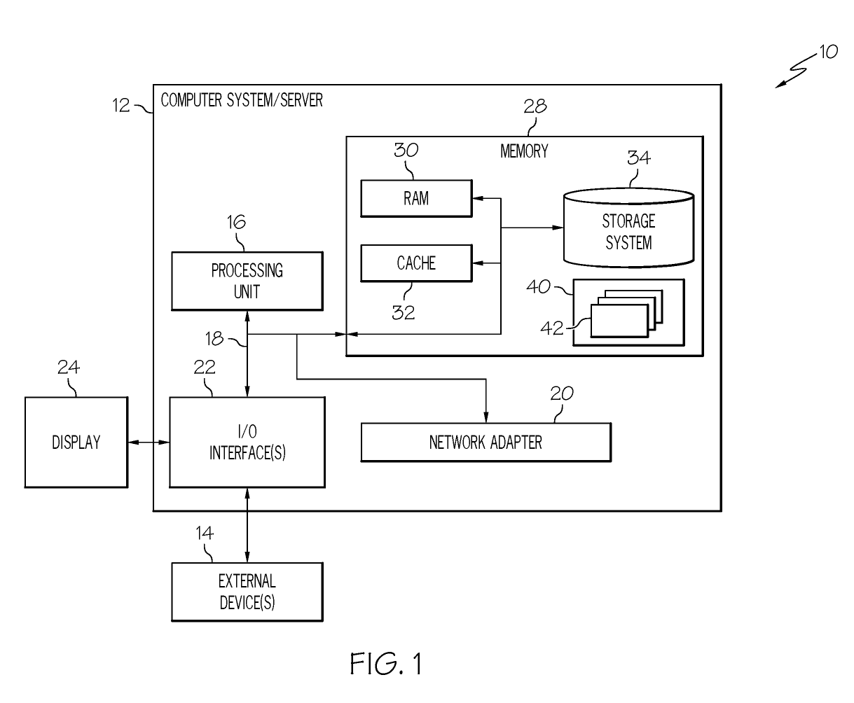

Referring now to FIG. 1, a schematic of an example of a cloud computing node for identifying an owner of a misplaced item is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

Further, referring to FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for identifying an owner of a misplaced item, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

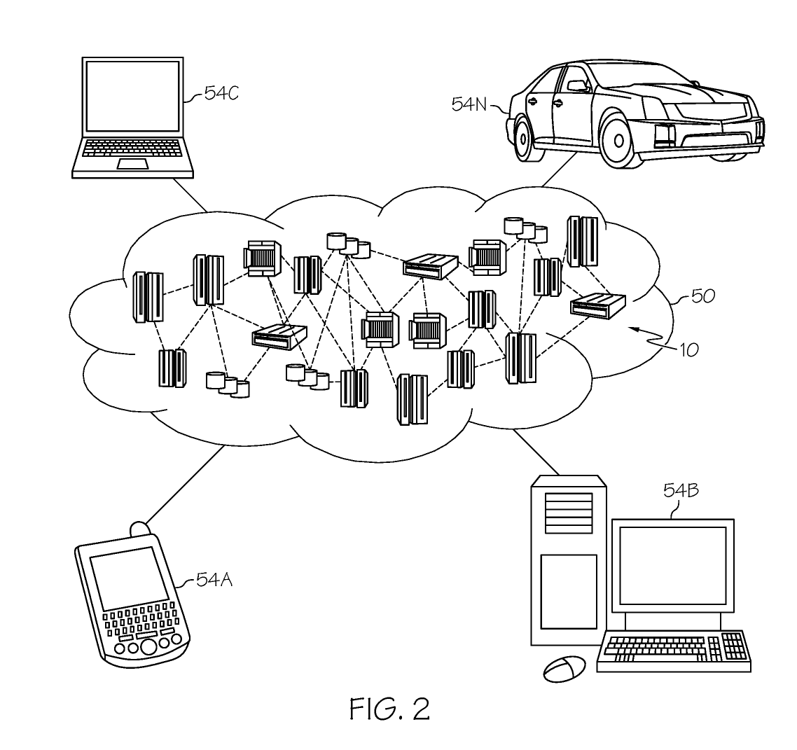

Referring now to FIG. 2, illustrative cloud computing environment 50 is depicted. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

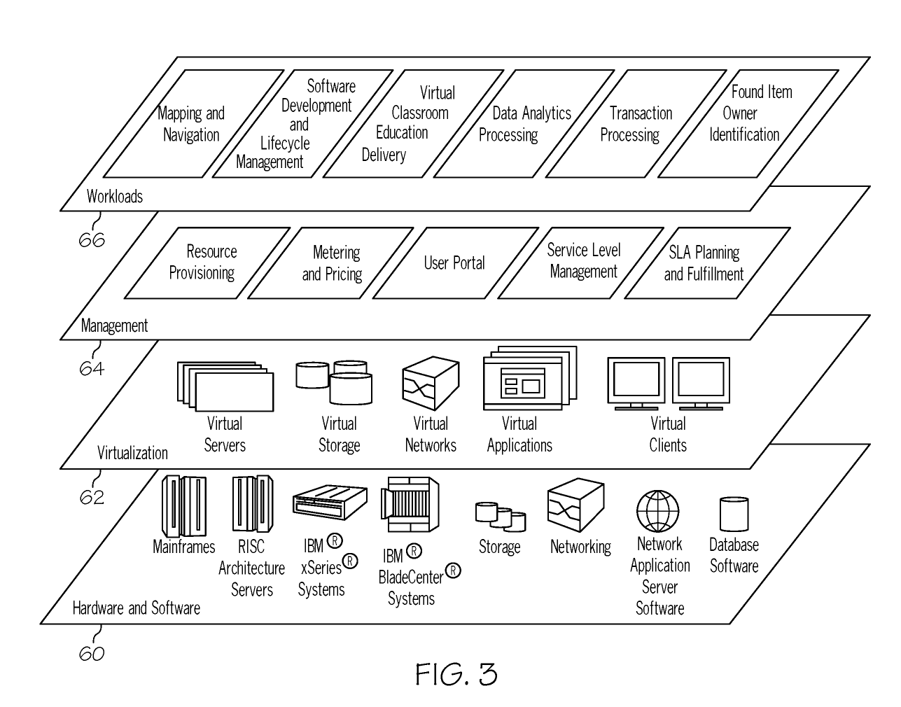

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM System X® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and found item owner identification. As mentioned above, all of the foregoing examples described with respect to FIG. 3 are illustrative only, and the invention is not limited to these examples.

It is understood that all functions of the present invention as described herein typically may be performed by the found item owner identification functionality (of workload layer 66, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, some embodiments of the present invention are intended to be implemented with any type of networked computing environment now known or later developed.

The inventors of the present invention have found that many current solutions for retuning lost items to owners, such as lost and found locations, classifieds, and online lost and found websites, often fail to successfully return the item to the owner. Even solutions that allow a finder to identify an owner have many deficiencies. For example, some solutions require an owner to place a tag on or retain a serial number of an item and then register that tag or serial number with a third-party service. In order for a finder of the item to contact the owner, he or she must recognize the presence of the tag or serial number and locate the third-party service the tag or serial number is registered with. This can be time consuming and require more effort than the owner or finder may be willing to spend.

The inventors of the present invention have discovered a system and method for finding a likely owner of a lost item, thereby facilitating retrieval of a lost item by an owner from a finder. Embodiments of the present invention offer several advantages, including, but not limited to, linking a lost item to an owner using a preferences profile derived from social media and decreasing time and effort that a finder and owner of a lost item expend in locating one another. In other words, embodiments of the present invention may be used to associate social media users with found items in order to facilitate the process of returning the item to its owner.

Certain embodiments of the present invention may offer various technical computing advantages, including automated and optimized searches for an owner of a misplaced item based on data obtained from social media profiles of potential owners of the misplaced item. Certain embodiments of the present invention develop profiles of misplaced items which have been found, connecting features of a misplaced item to characteristics typical of owners of such an item based on historically aggregated data. Certain embodiments of the present invention further draw upon information collected from social media users, including likely owners of a misplaced item, in order to develop profiles of the users detailing interests, lifestyles, and other personal preferences of the social media users. Comparison of the developed profiles of misplaced items and of the social media users enable efficient identification of likely owners of the misplaced item, thereby minimizing a search time by a finder of the item and increasing a number of successful reconnections between owners and misplaced items.

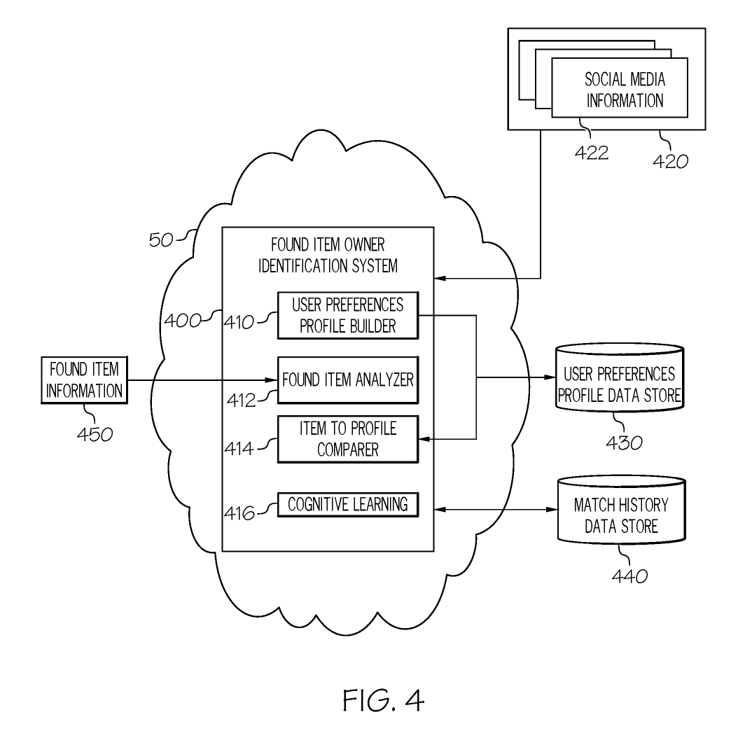

Referring now to FIG. 4, a more detailed system architecture for implementing identification of an owner of a found item based on a preferences profile of the owner according to illustrative embodiments is shown. Cloud computing environment 50 can contain found item owner identification system 400, which can, in some embodiments, be stored as a program/utility 40 in memory 28 of computer system/server 12 in cloud computing environment 50. Although described here as residing in cloud computing environment 50, it should be understood that in some embodiments of the present invention, found item owner identification system 400 can reside on a local server or computing device, such as a personal computer or mobile device.

In some embodiments, found item owner identification system 400 can include user preferences profile builder 410, found item analyzer 412, item to profile comparer 414, and cognitive learning component 416. These components operate to identify a likely owner of a misplaced item based on found item information 450 analyzed against social media or social network information 422. These components will be further described below in conjunction with an illustrative embodiment.

Found item owner identification system 400 can be a part of or in communication with social media service provider 420. Social media service provider 420 can include, for example, Facebook (a registered trademark of Facebook, Inc.), Twitter (a registered trademark of Twitter, Inc.), Instagram (a registered trademark of Instagram Inc.), Linkedin (a registered trademark of LinkedIn Corporation) and so on. Found item owner identification system 400 can retrieve social media information 422 from social media user profiles or feeds of users of social media service provider 420.

Found item owner identification system 400 can further include or be in communication with data store 430 containing generated user preferences profiles based on social media information 422 from social media user profiles. Found item owner identification system 400 can further include, or be in communication with, data store 440 containing a history of, at least, successful matches between an owner and a misplaced item to provide found item owner identification system 400 with cognitive learning.

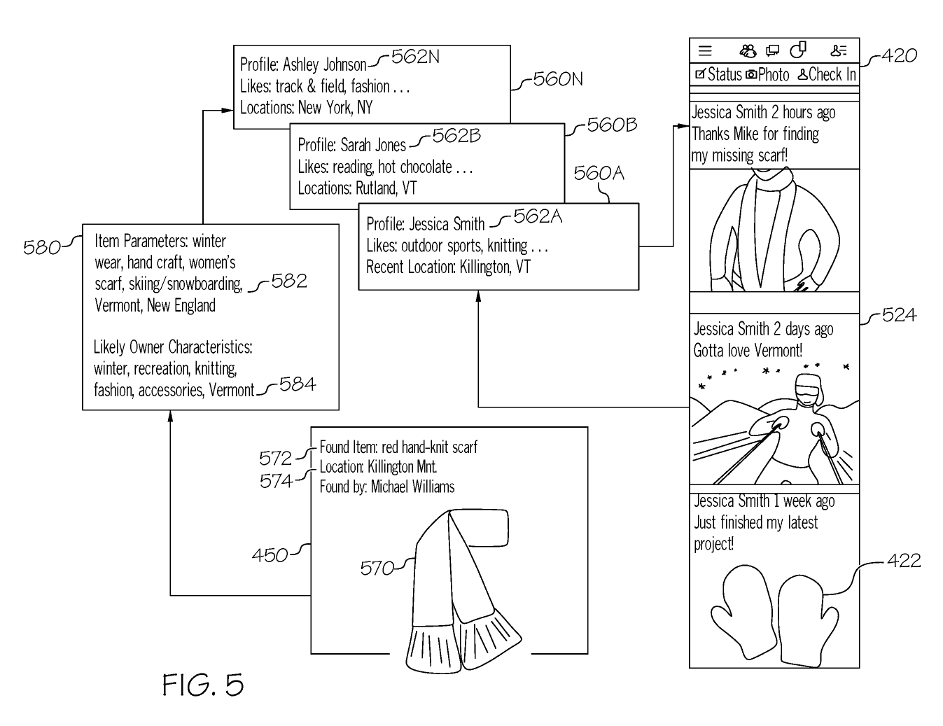

Referring now to FIG. 5, in conjunction with FIG. 4, an illustrative example of identifying an owner of a found item based on a preferences profile of the owner according to embodiments of the present invention is shown. User preferences profile builder 410 of found item owner identification system 400 gathers social media information 422 (e.g., location, demographics, employment, hobbies, frequently discussed topics, “liked” items, followings, favorite popular culture items such as music and movies, etc.) on a set of users from social media service provider 420. In some embodiments, user preferences profile builder 410 can also, or alternatively, gather data from sources other than social media, such as public records. In other embodiments, user preferences profiles 560A-N can be dynamically updated with changes or dynamically generated when new information is gathered from social media information 422. In further embodiments, user preferences profile builder 410 can, for example, gathers social media information 422 at an interval (e.g., periodically) or social media information 422 can be pushed to user preferences profile builder 410 by social media service provider 420 when social media service provider 420 detects new information has been added to a profile of one of its users.

In any case, user preferences profile builder 410 gathers social media or social network information 422 on the set of users into a set of user preferences profiles 560A-N. Social media information 422 can include, but is not limited to, a user profile on a social media platform; a status or posting of a user on social media; a feed of a user on social media; a following, liking, or sharing of a person, an item, a subject area, etc.; social media information of friends of the user, and so forth. Preferences described in user preferences profiles 560A-N can include categories of interest (e.g., movies, celebrities, books, music, sports), specific interests (e.g., hobbies), demographics (e.g., location, employment, estimated income), and tastes of users (e.g., lifestyle, favorite color), and so forth. In some embodiments, a user of social media service provider 420 may indicate whether he or she would like his or her information tracked for building a user preferences profiles 560 for recovery of lost items. For example, a user may give social media service provider 420 permission (e.g., by a sign-up, an opt-in, or an agreement to terms of service) to permit user preferences profile builder 410 access to social media information 422 on that user.

In some embodiments, user preferences profile builder 410 can use a software algorithm, such as IBM's Watson Personality Insights, to analyze text from a user and derive tastes, preferences, and personality therefrom. (Watson and IBM are trademarks of International Business Machines Corporation.) Watson Personality Insights extracts and analyzes a spectrum of personality attributes from text to help discover insights about people and entities. This service outputs personality characteristics, such as the Big 5, values, and needs. In further embodiments, user preferences profile builder 410 can use a software algorithm such as the IBM Multimedia Analysis and Retrieval System (IMARS), which provides built-in classifiers for visual categories including places, people, objects, settings, activities and events, to analyze photos and images of a user and derive tastes, preferences, and personality therefrom. (IMARS is a trademark of International Business Machines Corporation.)

In an illustrative example, user preferences profile builder 410 can gather social media information 422 on users 562A-N (Jessica, Sarah, and Ashley). User preferences profile builder 410 can determine from social media feed 524 of Jessica (user 562A) that Jessica is a sports enthusiast, enjoying many outdoor recreational activities, and is also an avid knitter. User preferences profile builder 410 may further determine from social media feed 524 that Jessica recently went skiing in Vermont at Killington Mountain. Likewise, user preferences profile builder 410 may determine from the social media feeds of Sarah (user 562B) and Ashley (user 562N) that Sarah is from Vermont, likes reading, and her favorite drink is hot chocolate, while Ashley lives in New York City, enjoys track and field, and works in the fashion industry.

A finder of found item 570 may report that he/she has found an apparently lost item. This reporting can be through any user interface system that relays found item information 450 reported by the finder to found item owner identification system 400, such as an application on a mobile device, a webpage, or so on. The finder may report found item information 450, including, for example, textual description 572 of found item 570, location 574 where item 570 was found, a photograph or image of item 570 and/or contact information of the finder.

In some embodiments, found item owner identification system 400 can provide a finder of found item 570 with feedback to guide the finder when taking an image of found item 570. Such feedback can include a notification or prompt in response to a submission of a photographic image by the finder. System 400 can evaluate factors affecting the ability of found item analyzer 412 to identify and analyze found item 570 in an uploaded image. Examples of factors that can affect the identification and analysis of item 570 in an image include, but are not limited to, a lighting of found item 570, a quality of the image, a sharpness of the image, and so forth. If, for example, a digital image is uploaded to system 400, but is too grainy for found item analyzer 412 to identify details of the item, system 400 can inform the finder that the image is of poor quality, suggest that the finder take an action to improve the quality of the image (e.g., place the item by a light source, adjust a resolution of a camera used to take the image, etc.) and prompt the finder to submit an additional image of a better quality.

Continuing the illustrative example from above with reference to FIG. 5, another user, Michael, may find an apparently lost scarf (found item 570). He may then report this find to found item owner identification system 400. This may be accomplished, for example, through any Internet-based reporting location available to a user, such as a mobile phone application, a web page, a social media page, and so forth. Michael may upload a picture of the scarf taken with an imaging device, such as a mobile phone with a camera. Michael may submit a textual description of the found scarf to found item owner identification system 400, such as “red hand-knit scarf.” Michael may further submit a location where the scarf was found, such as “Killington Mountain.” Michael may also identify himself as the finder of the lost scarf and provide information to allow the owner of the scarf to contact him.

Found item analyzer 412 processes and analyzes found item information 450 in response to the receipt of found item information 450 to generate found item profile 580. This processing and analysis can include using a software algorithm such as IBM's Watson Personality Insights and/or the IBM Multimedia Analysis and Retrieval System (IMARS) to discover parameters 582 about found item 570, such as an item identification from a visual analysis, a categorization of the item, and/or keywords associated with the item. For example, IMARS can identify found item 570 using object recognition to determine a type of item that item 570 is. Object recognition can include, for example, comparing a digital image of item 570 to images or specifications of items in an object recognition database. These parameters 582 from found item information 450 provided by the finder can be entered into found item profile 580. From discovered item parameters 582, found item analyzer 412 can deduce likely/typical characteristics 584 of the owner of found item 570 and enter likely/typical characteristics 584 into found item profile 580. This may be accomplished, for example, by found item analyzer 412 correlating certain item parameters 582 with characteristics 584 likely associated with those parameters. Characteristics 584 can include, but are not limited to, a category of interest (e.g., sports, music), an area of interest (e.g., baseball, rock music), a specific interest (e.g., a particular baseball team, a particular music group), a lifestyle range (e.g., an income level, a hobby, a type of employment), or a taste (e.g., a color, a type of item). For example, found item analyzer 412 could correlate a cost of the item with a likely income range of an owner, a category of the item with a likely taste or lifestyle of the owner, a type of item with a likely hobby or employment of the owner, etc. In some embodiments, correlations can be based on historical data, which will be described in more detail further below. In another embodiment, correlations can be based on data pulled from preexisting databanks that link certain characteristics to one another, such as found in social media.

Continuing the illustrative example from above with reference to FIG. 5, found item analyzer 412 receives, from the finder Michael, the uploaded picture of the found scarf along with the description “red hand-knit scarf” and the location where found, Killington Mountain, (found item information 450). Found item analyzer 412 processes and analyzes this information, determining item parameters 582, including that the scarf is winter wear, a hand craft, and a women's scarf, and that the location found is associated with skiing, snowboarding, Vermont, and New England. From parameters 582, found item analyzer 412 deduces that likely/typical characteristics 584 of the owner of the scarf might include winter, recreation, knitting, fashion, accessories, and Vermont.

Item to profile comparer 414 gathers, from user preferences profile data store 430, a set of user preferences profiles 560A-N that contain user preferences related (e.g., in a same category, having matching or associated keywords, linked in a knowledge web, etc.) to typical characteristics 584 indicated in found item profile 580. Item to profile comparer 414 reviews the set of user preferences profiles 560A-N for matches between typical characteristics 584 and likes, interests, personality, taste, demographics, locations, hobbies, employment, etc., of user preferences profiles 560A-N. Item to profile comparer 414 can further narrow a list of potential owners by searching for preference profiles 560A-N with a greater (e.g., more than an average) number of preference matches or near-matches, such as a preference for a color of item 570, a location near the location where item 570 was found, a lifestyle consistent with a cost of item 570, a taste for objects in the same category of item 570, and so on.

Although the above described embodiment uses pre-generated preferences profiles 560A-N, it should be understood that in some embodiments, preference profiles 560A-N can be created in response to the finding of an item and the creation of a found item profile 580. For example, once an item is found and item profile 580 of parameters 582 and likely/typical characteristics 584 is created, item to profile comparer 414 can search social media, a database of stored social media information, or other records for individuals having interests (e.g., indicated by a group membership, a following, or a like) matching or near-matching at least one likely characteristic 584. User preferences profile builder 410 can then build preference profiles 560A-N of individuals having interests associated with at least one likely characteristic 584. Item to profile comparer 414 can then further analyze newly generated preference profiles 560A-N to narrow a list of possible owners.

Furthermore, in the event that a possible owner has posted on social media that he/she is missing an item matching the description of found item 570, found item owner identification system 400 can forego generating and analyzing profiles of possible owners and skip directly to notifying a finder that the likely owner has been found. As described above for a finder of an item, in some embodiments, found item owner identification system 400 can provide a user who is an owner of a misplaced item with feedback to guide the user when posting an image of the misplaced item, such as a notification or prompt asking for a higher quality image or several images (e.g., to compensate for images being low quality) to allow an image analyzer to better identify and learn features of the misplaced item.

Item to profile comparer 414 can, in some embodiments, further calculate a likelihood or confidence that found item 570 belongs to each user 562A-N of set of gathered user preferences profiles 560A-N. In some embodiments, this likelihood or confidence can be in the form of a percent or probability ratio, or a ranked/ordered list from most likely to least likely. In some embodiments, item to profile comparer 414 can be configured to remove from the gathered preference profiles a profile of any user 562A-N with a confidence of ownership below a certain threshold or below a certain threshold ranking on a list. The likelihood that found item 570 belongs to each user 562A-N may be calculated using any solution (e.g., machine learning, rule-based artificial intelligence, etc.) now known or later developed that assesses a strength of a relationship between a profile of a user and certain terms, keywords, etc. This can include a method that makes a best effort to match parameters of found item 570 with an entry in user preferences profile data store 430.

Continuing the illustrative example from above with reference to FIG. 5, based on the determination that typical characteristics 584 of the owner of the scarf might include winter, recreation, knitting, fashion, accessories, and Vermont, item to profile comparer 414 gathers a set of user preferences profiles 560A-N having at least some of these characteristics, including the profiles of Jessica (562A), Sarah (562B), and Ashley (562N). Item to profile comparer 414 determines that portions of Jessica and Ashley's preferences profiles overlap with likely characteristics 584 including that they both enjoy outdoor recreational activities and have an interest in knitting and fashion, respectively, but only Jessica has recently been to Killington Mountain in Vermont. Item to profile comparer 414 further determines that, while Sarah lives in Vermont and enjoys some winter activities, she has a stronger preference for indoor activities and therefore has less overlap with likely characteristics 584. From this analysis, item to profile comparer 414 calculates that Jessica is the most likely user of users 562A-N to be the owner of found item 570 with a confidence of, for example, 90%, based on several of her preferences corresponding to likely characteristics 584 and her location near where the scarf was found. Item to profile comparer 414 can further calculate that Sarah and Ashley, due to Sarah's unrelated area of interests and Ashley's removed location, only have a confidence, for example, of 45% and 40%, respectively, of being the owner.

Found item owner identification system 400 can present one or more users 562A-N to the finder of found item 570 as potential owners of the item. In some embodiments, potential owners of the item may be presented along with a level of confidence or level of likelihood that each is the actual owner of item 570. This presentation can be in the form of a notification to the finder that potential owners have been found and can include, for example, an email, a text message, or an in-application message. In some embodiments, found item owner identification system 400 only presents to the finder users who have an associated level of confidence or likelihood that he or she is the owner above a predetermined threshold. Accordingly, in some instances, no user will have an associated level of confidence or likelihood that he or she is the owner above a predetermined threshold. In this case, found item owner identification system 400 can, for example, inform the finder that no possible owners have been found. In some embodiments, found item owner identification system 400 can also continue to periodically search for possible owners or simply not return any notification to the finder.

In some embodiments, found item owner identification system 400 can also notify one or more of the possible owners that an item has been found that may belong to them. This notification to a potential owner can, in some embodiments, be automatic and, in other embodiments, can be at the prompt of the finder. In some embodiments, potential owners may be notified in a descending order of confidence in the potential ownership, with the ordered notifications ceasing after the owner identifies himself or herself. In still other embodiments, found item owner identification system 400 can present the finder with contact information for one or more potential owners and permit the finder to use this contact information to independently contact the potential owner. In still other embodiments, found item owner identification system 400 can present a potential owner with contact information of the finder. In some embodiments, the finder and owner may, independent of found item owner identification system 400, decide how to return item 570 to the owner, while in other embodiments, a service associated with found item owner identification system 400 (e.g., a courier service) can be used to return item 570 to the owner. The finder or owner of found item 570 may report to found item owner identification system 400 which of the potential owners identified is the actual owner so that found item owner identification system 400 can add the successful match of item and owner to a data store of a cognitive learning system.

Still continuing the illustrative example from above with reference to FIG. 5, found item owner identification system 400 can present finder Michael with a list of potential owners (Jessica, Sarah, and Ashley, among others), having confidences of ownership of 90%, 45%, and 40%, respectively, along with contact information (e.g., email, phone number, link to social media profile, etc.) for Jessica, the most likely owner. Michael may then contact Jessica, and upon learning that she is the owner of the lost scarf (item 570), arrange to return the scarf to her. If Michael were instead to learn that Jessica was not the scarf's owner, he might then contact Sarah, and then Ashley, using contact information provided by found item owner identification system 400.

In additional embodiments, found item owner identification system 400 can also be used to narrow a group of possible owners of an item by eliminating less likely owners. Item to profile comparer 414 can determine whether a potential owner has characteristics of a person likely to own a particular found item or if the potential owner has characteristics that contradict the likeliness that he or she owns the item. For example, a person whose social media accounts and public record show that he or she has never been married is less likely to be an owner of a found wedding ring. Likewise, a person whose social media shows he or she dislikes country music is less likely to own a guitar, and a person who engages in less social media than average is less likely to own a most recently released version of a personal mobile device.

Found item owner identification system 400 can also be used in conjunction with existing lost and found item owner identification systems, such as those associated with serial numbers or tags, online lost and founds and classifieds, real-world lost and founds and classifieds, and object recognition systems based on images of a lost item and a found item that may match the lost item. For example, found item owner identification system 400, as described above, can be used to provide a second level of scrutiny to determine if a purported owner is likely the true owner of a found item.

In further embodiments of the present invention, found item owner identification system 400 can include a cognitive learning system, having cognitive learning component 416 and match history data store 440, storing historical data on previous successful and unsuccessful possible owner identifications, for learning from these previous identifications. Cognitive learning component 416 can store, in match history data store 440, matches between lost items 570 and possible owner preferences profiles 560A-N, along with feedback indicating whether the possible owner is the actual owner. In other words, as found item owner identification system 400 is used to match user preference profiles to found items, system 400 can correlate and retain the combination of data (e.g., location, interests, hobbies, income, lifestyle, etc.) used for a successful owner identification. In some embodiments, this information can be entered into a knowledge web, such as a semantic web, to correlate certain characteristics with preferences or items likely owned by someone with those preferences, allowing for improved and more accurate predictions in the future, including providing a level of certainty (e.g., percent certainty) that a possible owner is the actual owner of a given item or a strength of correlation between preferences of a user and a given item.

In further embodiments of the present invention, found item owner identification system 400 can include a cognitive learning system, having cognitive learning component 416 and match history data store 440 storing historical data on previous successful and unsuccessful possible owner identifications. Cognitive learning component 416 can store, in match history data store 440, matches between lost items 570 and possible owner preferences profiles 560A-N, along with feedback indicating whether the possible owner is the actual owner. In other words, as found item owner identification system 400 is used more to match user preference profiles to found items, system 400 can retain the combination of historical data (e.g., location, interests, hobbies, income, lifestyle, etc.) used for a successful owner identification. This information can be entered into a knowledge web, such as a semantic web, to correlate certain characteristics with preferences or items likely owned by someone with those preferences, allowing for improved and more accurate predictions in the future, including providing a given certainty (e.g., percent certainty) that a possible owner is the actual owner of a given item.

For example, continuing the illustrative example from above with reference to FIG. 5, the successful match between Jessica, whose preferences include outdoor sports and knitting, and the found hand-knit scarf can be entered in a knowledge web in data store 440, thereby linking scarves and outdoor sports. If Jessica's preferences profile also shows that she owns a cat, the knowledge web can likewise be updated to include knowledge links between knitting, outdoor sports, and cat ownership. Conversely, the unsuccessful match between Ashley, whose preferences profile includes track and field and fashion, and the found hand-knit scarf can be entered in the knowledge web to indicate that a preference for track and field has little correlation with scarves.

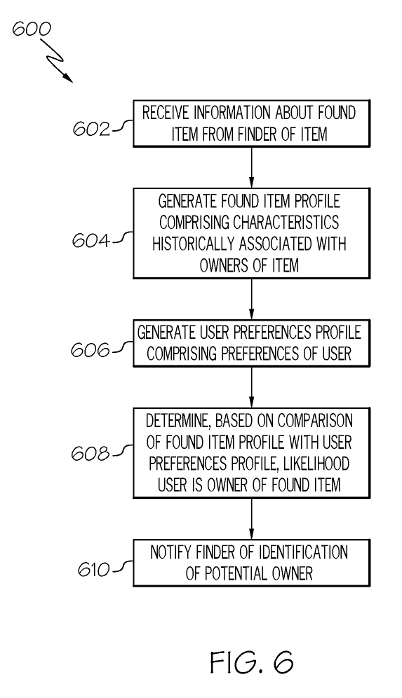

As depicted in FIG. 6, in one embodiment, a system (e.g., computer system 12) carries out the methodologies disclosed herein. Shown is a process flowchart 600 for identifying an owner of a misplaced item. At step 602, information 450 about found item 570 from a finder of found item 570 is received. At step 604, based on received information 450, a found item profile 580 comprising a set of characteristics historically associated with owners of found item 570 is generated. At step 606, a user preferences profile 560 comprising a set of preferences of user 562 is generated. At step 608, a likelihood that user 562 is the owner of found item 570 is determined based on a comparison of found item profile 580 with user preferences profile 560. At step 610, the finder is notified, in response to the likelihood being above a predetermined threshold, of an identification of a potential owner based on the determination.

Process flowchart 600 of FIG. 6 illustrates the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for identifying an owner of a misplaced item. Thus, embodiments herein disclose a process for supporting computer infrastructure, comprising integrating, hosting, maintaining, and deploying computer-readable code into a computing system (e.g., computer system 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for identifying an owner of a misplaced item. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to identify an owner of a misplaced item. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for identifying an owner of a misplaced item, the computer-implemented method comprising:
receiving information about a found item from a finder of the found item;
generating, based on the received information, a found item profile comprising a set of characteristics historically associated with owners of the found item;
generating a user preferences profile comprising a set of preferences of a user;
determining, based on a comparison of the found item profile with the user preferences profile, a likelihood that the user is the owner of the found item; and
notifying, in response to the likelihood being above a predetermined threshold, the finder of an identification of a potential owner based on the determination.

2. The computer-implemented method of claim 1, the method further comprising designating the user a potential owner in the case that the likelihood is within a threshold confidence level.

3. The computer-implemented method of claim 1, the method further comprising:
receiving a confirmation that the user is the owner of the found item; and
entering the user preferences profile and the found item profile into a data store of a cognitive learning system.

4. The computer-implemented method of claim 3, the set of characteristics historically associated with owners of the found item being based on knowledge from the cognitive learning system.

5. The computer-implemented method of claim 1, the information about the found item comprising at least one of the group consisting of: a description of the found item, a picture of the found item, and a location where the found item was found.

6. The computer-implemented method of claim 1, the set of preferences of the user being retrieved from at least one of the group consisting of: a social network profile, a social network status, a social network feed, and a public record.

7. The computer-implemented method of claim 6, the set of preferences of the user being selected from the group consisting of: a personal taste, an interest, a hobby, an income, a type of employment, a demographic, a lifestyle, a location, and preferences.

8. A computer system for identifying an owner of a misplaced item, the computer system comprising:
a memory medium comprising program instructions;
a bus coupled to the memory medium; and
a processor, for executing the program instructions, coupled to a found item owner identifier via the bus that when executing the program instructions causes the system to:
receive information about a found item from a finder of the found item;
generate, based on the received information, a found item profile comprising a set of characteristics historically associated with owners of the found item;
generate a user preferences profile comprising a set of preferences of a user;
determine, based on a comparison of the found item profile with the user preferences profile, a likelihood that the user is the owner of the found item; and
notify, in response to the likelihood being above a predetermined threshold, the finder of an identification of a potential owner based on the determination.

9. The computer system of claim 8, the instructions further causing the system to designate the user a potential owner in the case that the likelihood is within a threshold confidence level.

10. The computer system of claim 8, the instructions further causing the system to:
receive a confirmation that the user is the owner of the found item; and
enter the user preferences profile and the found item profile into a data store of a cognitive learning system.

11. The computer system of claim 10, the set of characteristics historically associated with owners of the found item being based on knowledge from the cognitive learning system.

12. The computer system of claim 8, the information about the found item comprising at least one of the group consisting of: a description of the found item, a picture of the found item, and a location where the found item was found.

13. The computer system of claim 8, the set of preferences of the user being retrieved from at least one of the group consisting of: a social network profile, a social network status, a social network feed, and a public record.

14. The computer system of claim 13, the set of preferences of the user being selected from the group consisting of: a personal taste, an interest, a hobby, an income, a type of employment, a demographic, a lifestyle, a location, and preferences.

15. A computer program product for identifying an owner of a misplaced item, the computer program product comprising a computer readable storage device, and program instructions stored on the computer readable storage device, to:
receive information about a found item from a finder of the found item;
generate, based on the received information, a found item profile comprising a set of characteristics historically associated with owners of the found item;
generate a user preferences profile comprising a set of preferences of a user;
determine, based on a comparison of the found item profile with the user preferences profile, a likelihood that the user is the owner of the found item; and
notify, in response to the likelihood being above a predetermined threshold, the finder of an identification of a potential owner based on the determination.

16. The computer program product of claim 15, the computer readable storage device further comprising instructions to designate the user a potential owner in the case that the likelihood is within a threshold confidence level.

17. The computer program product of claim 15, the computer readable storage device further comprising instructions to:
receive a confirmation that the user is the owner of the found item; and
enter the user preferences profile and the found item profile into a data store of a cognitive learning system.

18. The computer program product of claim 17, the set of characteristics historically associated with owners of the found item being based on knowledge from the cognitive learning system.

19. The computer program product of claim 15, the information about the found item comprising at least one of the group consisting of: a description of the found item, a picture of the found item, and a location where the found item was found.

20. The computer program product of claim 15, the set of preferences of the user being retrieved from at least one of the group consisting of: a social network profile, a social network status, a social network feed, and a public record, and the set of preferences of the user being selected from the group consisting of: a personal taste, an interest, a hobby, an income, a type of employment, a demographic, a lifestyle, a location, and preferences.
